(19) United States
(12) Patent Application Publication
(10) Pub. No.: US 2022/0080980 A1
(43) Pub. Date: Mar. 17, 2022

(54) DEVICE FOR PREDICTING SPEED OF VEHICLE AND METHOD THEREOF

(71) Applicants: Hyundai Motor Company, Seoul (KR); Kia Corporation, Seoul (KR)

(72) Inventors: Dong Hoon JEONG, Hwaseong-Si (KR); Byeong Wook JEON, Seoul (KR); Min Jae CHAI, Suwon-Si (KR); Yong Uk SHIN, Seongnam-Si (KR)

(73) Assignees: Hyundai Motor Company, Seoul (KR); Kia Corporation, Seoul (KR)

(21) Appl. No.: 17/246,202

(22) Filed: Apr. 30, 2021

(30) Foreign Application Priority Data
Sep. 15, 2020 (KR) 10-2020-0118481

(51) Int. Cl. B60W 40/105; B60W 50/00; G07C 5/04; G06N 3/04; G06N 3/08

(52) U.S. Cl. CPC B60W 40/105; B60W 2050/0031; G07C 5/04; G06N 3/0454; G06N 3/08; B60W 2556/10; B60W 2540/10; B60W 2552/20; B60W 2540/18; B60W 2540/12; B60W 2554/802; B60W 2510/1005; B60W 2520/10; B60W 2510/182; B60W 2554/804; B60W 2552/30; B60W 50/0097

(57) ABSTRACT

The present invention relates to a device configured for predicting a speed of a vehicle, and a method thereof. To predict the speed of the vehicle with high accuracy in a form of time-series data, the present invention may include an input device entering time-series data for a driving profile before a prediction time point into an encoder, a learning device learning a vehicle speed model by use of a low-dimensional representation which is an output of the encoder, a vehicle speed at the prediction time point, and a driving profile at the prediction time point, and a controller predicting a speed of the vehicle based on the vehicle speed model.

### CROSS-REFERENCE TO RELATED APPLICATION

The present application claims priority to Korean Patent Application No. 10-2020-0118481, filed on Sep. 15, 2020, the entire contents of which is incorporated herein for all purposes by this reference.

### BACKGROUND OF THE INVENTION

### Field of the Invention

The present invention relates to a technology for predicting a speed of a vehicle based on a variational auto-encoder (VAE).

### Background of the Invention

Generally, deep learning or deep neural network is a type of machine learning, and is composed of several layers of artificial neural networks (ANNs) between an input and an output.

According to structures, problems to be solved, and purposes, ANN may include VAE in addition to a convolution neural network (CNN) mainly used in a vision field and a recurrent neural network (RNN) that mainly deals with sequence data such as a natural language, voice, or the like.

The VAE is an unsupervised data learning technology that models a data set (X) of an input variable as a low-dimensional representation (Z) indicating an average of a normal distribution and extracts a feature of X from the Z. The VAE may extract a feature of the data set (X) in a form of a low-dimensional representation (Z), by repeatedly learning a process of matching a reconstructed output (X′) with the data set (X). At the instant time, the input and output of VAE are the same variables as each other.

The present invention provides a method of predicting a speed of a vehicle by receiving past time-series data (e.g., a driving profile) and outputting future time-series data (e.g., a speed of a vehicle) based on the VAE.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a device and method for predicting a speed of a vehicle which may predict the speed of the vehicle with high accuracy in a form of time-series data, by entering time-series data for a driving profile before a prediction time point into an encoder, generating a vehicle speed model for predicting the speed of the vehicle based on a low-dimensional representation (Z), which is an output of the encoder, and a vehicle speed at a prediction time point and a driving profile at the prediction time point, which are additionally entered, and predicting the speed of the vehicle based on the vehicle speed model.

Various aspects of the present invention provide a device and method for predicting a speed of a vehicle which may predict the speed of the vehicle with high accuracy in a form of time-series data, by entering time-series data for a driving profile before a prediction time point and a driving profile at the prediction time point into an encoder, generating a vehicle speed model for predicting the speed of the vehicle based on a low-dimensional representation (Z), which is the output of the encoder, and the vehicle speed at the prediction time point which is additionally entered, and predicting the speed of the vehicle based on the vehicle speed model.

Objects of the present invention are not limited to the above-mentioned object, and other objects and advantages of the present invention which is not mentioned will be understood from the following description, and it will be apparently understood from various exemplary embodiments of the present invention. Furthermore, it will be easily understood that the objects and advantages of the present invention are realized by means and combinations described in the appended claims.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, a speed prediction device of a vehicle based on variational auto-encoder (VAE) may include an input device entering time-series data for a driving profile before a prediction time point into an encoder, a learning device learning a vehicle speed model by use of a low-dimensional representation which is an output of the encoder, a vehicle speed at the prediction time point, and the driving profile at the prediction time point, and a controller predicting a speed of the vehicle based on the vehicle speed model.

In various exemplary embodiments of the present invention, the driving profile may include at least one of a gas pedal position (GPP) value of the vehicle, a gradient of a road, a steering angle of the vehicle, a brake state of the vehicle, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

In various exemplary embodiments of the present invention, the vehicle speed model may be used to output the vehicle speed in a format of the time-series data.

In various exemplary embodiments of the present invention, the encoder may model a feature of the time-series data for the driving profile before the prediction time point into the low-dimensional representation distributed in a first area.

According to various aspects of the present invention, a speed predicting method of a vehicle based on a VAE may include entering, by an input device, time-series data for a driving profile before a prediction time point into an encoder, learning, by a learning device including the encoder, a vehicle speed model by use of a low-dimensional representation which is an output of the encoder, a vehicle speed at the prediction time point, and a driving profile at the prediction time point, and predicting, by a controller, a speed of the vehicle based on the vehicle speed model.

According to various aspects of the present invention, a speed prediction device of a vehicle based on VAE may include an input device entering time-series data for a driving profile before a prediction time point and the driving profile at the prediction time point into an encoder, a learning device learning a vehicle speed model by use of a low-dimensional representation which is an output of the encoder, and a vehicle speed at the prediction time point, and a controller predicting a speed of the vehicle based on the vehicle speed model.

In another exemplary embodiment of the present invention, the driving profile may include at least one of a gas pedal position (GPP) value of the vehicle, a gradient of a road, a steering angle of the vehicle, a brake state of the vehicle, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

In another exemplary embodiment of the present invention, the vehicle speed model may be used to output the vehicle speed in a format of the time-series data.

In another exemplary embodiment of the present invention, the encoder may model a feature of the time-series data for the driving profile before the prediction time point into the low-dimensional representation distributed in a first area.

According to various aspects of the present invention, a speed predicting method of a vehicle based on a VAE may include entering, by an input device, time-series data for a driving profile before a prediction time point and a driving profile at the prediction time point into an encoder, learning, by a learning device including the encoder, a vehicle speed model by use of a low-dimensional representation which is an output of the encoder, and a vehicle speed at the prediction time point, and predicting, by a controller, a speed of the vehicle based on the vehicle speed model.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a speed prediction device of a vehicle according to various exemplary embodiments of the present invention;

FIG. 2 is an exemplary diagram illustrating a learning process of a learning device included in a speed prediction device of a vehicle according to various exemplary embodiments of the present invention;

FIG. 3 is an exemplary diagram illustrating a distribution of a low-dimensional representation in a first vehicle speed model, which is generated by a learning device included in a speed prediction device of a vehicle, according to various exemplary embodiments of the present invention;

FIG. 4 is another exemplary diagram illustrating a learning process of a learning device included in a speed prediction device of a vehicle according to various exemplary embodiments of the present invention;

FIG. 5 is an exemplary diagram illustrating a distribution of low-dimensional representations in a second vehicle speed model, which is generated by a learning device included in a speed prediction device of a vehicle, according to various exemplary embodiments of the present invention;

FIG. 6A and FIG. 6B are exemplary diagrams of a performance analysis diagram of a speed prediction device of a vehicle according to various exemplary embodiments of the present invention;

FIG. 7 is a flowchart of a method for predicting a speed of a vehicle according to various exemplary embodiments of the present invention;

FIG. 8 is a flowchart of a speed prediction method of a vehicle according to various exemplary embodiments of the present invention; and

FIG. 9 is a block diagram illustrating a computing system for performing a method of predicting a speed of a vehicle, according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of well-known features or functions will be ruled out in order not to unnecessarily obscure the gist of the present invention.

In describing the components of the exemplary embodiment according to various exemplary embodiments of the present invention, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which various exemplary embodiments of the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

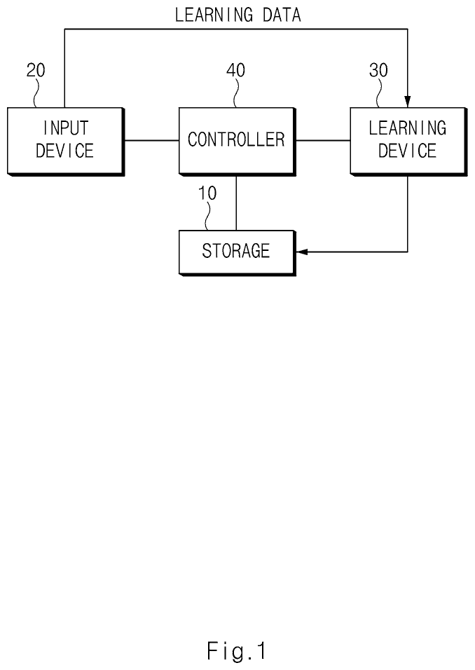

FIG. 1 is a block diagram of a speed prediction device of a vehicle according to various exemplary embodiments of the present invention.

As illustrated in FIG. 1, a speed prediction device of a vehicle according to various exemplary embodiments of the present invention may include storage 10, an input device 20, a learning device 30, and a controller 40. At the instant time, according to various exemplary embodiments of the present invention, according to a method of operating the speed prediction device of a vehicle, each of the components may be implemented as one device after being coupled with one another or a portion of the components may be omitted. In particular, a function of the learning device 30 may be implemented to be performed by the controller 40.

Referring to each of the components, first of all, the storage 10 may store various logics, algorithms and programs that are required in a processing of entering time-series data for a driving profile before a prediction time point (a point in time when a prediction is attempted) into an encoder, learning a first vehicle speed model for predicting a speed of a vehicle based on a low-dimensional representation (Z), which is an output of the encoder, and a vehicle speed at the prediction time point and a driving profile at the prediction time point that are additionally entered, and predicting the speed of the vehicle based on the learned first vehicle speed model. At the instant time, the storage 10 may store the learned first vehicle speed model such that the controller 40 is configured for using the first vehicle speed model.

In another exemplary embodiment of the present invention, the storage 10 may store various logics, algorithms, and programs that are required in a processing of entering the time-series data for the driving profile before the prediction time point and the driving profile at the prediction time point into the encoder, learning a second vehicle speed model for predicting a speed of a vehicle based on a low-dimensional representation (Z), which is an output of the encoder, and a vehicle speed at the prediction time point which is additionally entered, and predicting the speed of the vehicle based on the learned second vehicle speed model. At the instant time, the storage 10 may store the learned second vehicle speed model such that the controller 40 is configured for using the second vehicle speed model.

The storage 10 may include at least one type of a storage medium among a flash memory type of a memory, a hard disk type of a memory, a micro type of a memory, and a card type (e.g., a Secure Digital (SD) card or an eXtream Digital (XD) Card) of a memory, a Random Access Memory (RAM) type of a memory, a Static RAM (SRAM) type of a memory, a Read-Only Memory (ROM) type of a memory, a Programmable ROM (PROM) type of a memory, an Electrically Erasable PROM (EEPROM) type of a memory, an Magnetic RAM (MRAM) type of a memory, a magnetic disk type of a memory, and an optical disc type of a memory.

In various exemplary embodiments of the present invention, in a process of learning the first vehicle speed model, the input device 20 may enter the time-series data for the driving profile before the prediction time point into the encoder of the VAE and may enter the low-dimensional representation (Z), which is the output of the encoder, and the vehicle speed at the prediction time point and the driving profile at the prediction time point into a decoder of the VAE.

Herein, the driving profile before the prediction time point is a value measured during a predetermined time period based on a current time point, and refers to information for forming a driving pattern of the vehicle. The driving profile may include a gas pedal position (GPP) value, revolutions per minute (RPM),

a gear stage, a vehicle speed, a gradient of a road, a curvature of the road, a steering angle, a brake pedal position (BPP) value (brake on/off or brake pressure), a separation distance from a preceding vehicle, a relative speed with the preceding vehicle, traffic light information in front, or the like. At the instant time, the driving profile is time-series data measured during a predetermined time period.

Furthermore, the driving profile at the prediction time point indicates a value measured at the current time point. At the instant time, the GPP value, the RPM, the gear stage, the vehicle speed, the steering angle, and the BPP value may be obtained through a vehicle network. The gradient and curvature of the road may be obtained from a navigation device provided in the vehicle. The separation distance from the preceding vehicle and the relative speed with the preceding vehicle may be obtained from the radar provided in the vehicle. The traffic light information in front (information related to turning on/off a traffic light) may be obtained from a traffic light controller.

Furthermore, in a process of predicting the speed of the vehicle based on the learned first vehicle speed model, the input device 20 may enter the time-series data for the driving profile before the prediction time point into the encoder of the VAE and may enter the low-dimensional representation (Z), which is the output of the encoder, and the vehicle speed at the prediction time point and the driving profile at the prediction time point into a decoder of the VAE.

In another exemplary embodiment of the present invention, in a process of learning the second vehicle speed model, the input device 20 may enter the time-series data for the driving profile before the prediction time point and the driving profile at the prediction time point into the encoder of the VAE, and may enter the low-dimensional representation (Z), which is the output of the encoder, and the vehicle speed at the prediction time point into the decoder of the VAE.

Moreover, in a process of predicting the speed of the vehicle based on the learned second vehicle speed model, the input device 20 may enter the time-series data for the driving profile before the prediction time point and the driving profile at the prediction time point into the encoder of the VAE, and may enter the low-dimensional representation (Z), which is the output of the encoder, and the vehicle speed at the prediction time point into the decoder of the VAE.

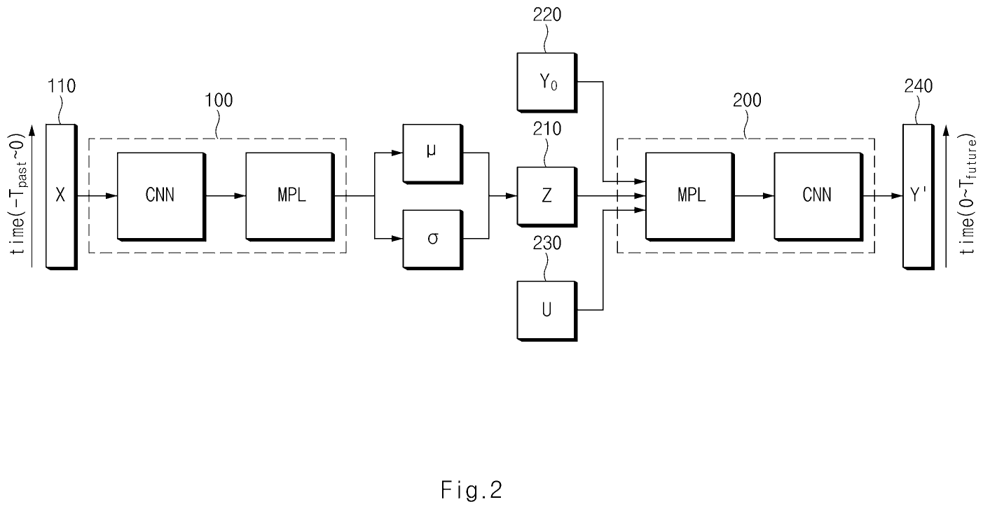

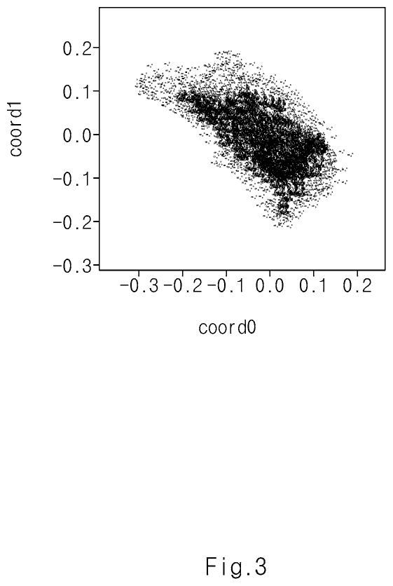

In various exemplary embodiments of the present invention, the learning device 30 may learn a first vehicle speed model for predicting the speed of the vehicle, based on the low-dimensional representation (Z), which is the output of the encoder, and the vehicle speed at the prediction time point and the driving profile at the prediction time point that are additionally entered. That is, the learning device 30 may generate the learned first vehicle speed model. Hereinafter, a learning process of the learning device 30 will be described with reference to FIG. 2 and FIG. 3.

FIG. 2 is an exemplary diagram illustrating a learning process of a learning device included in a speed prediction device of a vehicle according to various exemplary embodiments of the present invention.

As illustrated in FIG. 2, the learning device 30 included in a speed prediction device of a vehicle according to various exemplary embodiments of the present invention may learn a first vehicle speed model based on VAE.

‘100’ denotes a probabilistic encoder. ‘110’ is learning data for a driving profile, and denotes time-series data (X) during a reference time (Tₚₐₛₜ˜Tₚᵣₑₛₑₙₜ) before a prediction time point (Tₚᵣₑₛₑₙₜ). ‘200’ denotes a probabilistic decoder. ‘210’ denotes a low-dimensional representation (Z) which is an output of an encoder. ‘220’ denotes a vehicle speed (a current vehicle speed) at the prediction time point. ‘230’ denotes a driving profile at the prediction time point. ‘240’ denotes a predicted future speed (Y′) of a vehicle. At the instant time, Y′ may be a speed of the vehicle during a period (Tₚᵣₑₛₑₙₜ˜T_{future}) after a reference time from a current time point, and may be expressed in the format of time-series data. Furthermore, indicates an average of a distribution, and a indicates a variance of the distribution.

An encoder 100 may have a convolution neural network (CNN) and a Multi perceptron Layer (MPL). A decoder 200 may include a MPL and a CNN.

In various exemplary embodiments of the present invention, a decoder (p_{θ}(x|z)) is parameterized by a deep neural network having parameter θ. An encoder (p_{Φ}(x|z)) is parameterized by the deep neural network having parameter Φ. The low-dimensional representation z is defined to embed compression information related to data X. The encoder 100 maps a data space to a potential space. The encoder 100 and decoder 200 are parameterized by use of a diagonal Gaussian distribution.

FIG. 3 is an exemplary diagram illustrating a distribution of low-dimensional representations in a first vehicle speed model, which is generated by a learning device included in a speed prediction device of a vehicle, according to various exemplary embodiments of the present invention.

As illustrated in FIG. 3, the learning device 30 included in the speed prediction device of a vehicle according to various exemplary embodiments of the present invention may model a feature of time-series data for a driving profile before a prediction time point into low-dimensional representations (Z) distributed in a relatively narrow space, based on the encoder 100.

In another exemplary embodiment of the present invention, the learning device 30 may learn a second vehicle speed model for predicting a speed of a vehicle, based on the low-dimensional representation (Z), which is an output of an encoder, and a vehicle speed at the prediction time point which is additionally entered. That is, the learning device 30 may generate the learned second vehicle speed model.

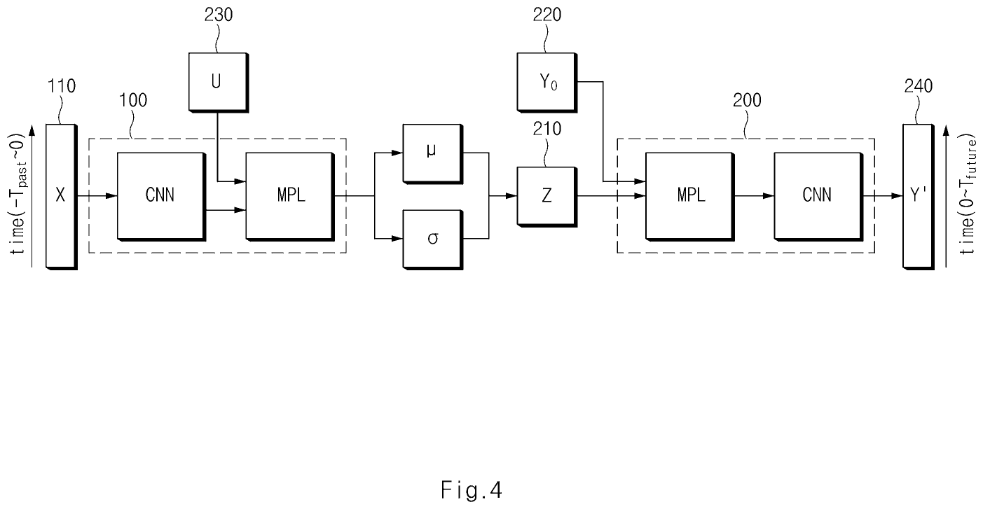

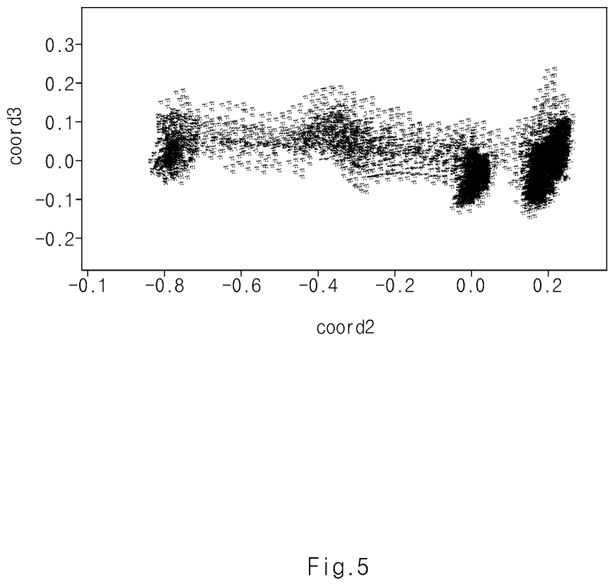

Hereinafter, a learning process of the learning device 30 will be described with reference to FIG. 4 and FIG. 5.

FIG. 4 is another exemplary diagram illustrating a learning process of a learning device included in a speed prediction device of a vehicle according to various exemplary embodiments of the present invention.

As illustrated in FIG. 4, the learning device 30 included in a speed prediction device of a vehicle according to various exemplary embodiments of the present invention may learn a second vehicle speed model based on VAE.

FIG. 5 is an exemplary diagram illustrating a distribution of low-dimensional representations in a second vehicle speed model, which is generated by a learning device included in a speed prediction device of a vehicle, according to various exemplary embodiments of the present invention.

As illustrated in FIG. 5, the learning device 30 included in the speed prediction device of a vehicle according to various exemplary embodiments of the present invention may model a feature of input data (time-series data for a driving profile before a prediction time point and a driving profile at the prediction time point) into low-dimensional representations (Z) distributed in a wide narrow space, based on the encoder 100. The reason is that the driving profile information at the prediction time point is reflected.

In the meantime, the controller 40 may perform overall control such that each of the components is configured for normally performing functions of the components. The controller 40 may be implemented in a form of hardware, may be implemented in a form of software, or may be implemented in a form of the combination of hardware and software. Favorably, the controller 40 may be implemented as a microprocessor, but is not limited thereto.

The controller 40 may control the learning device 30 to enter time-series data for the driving profile before the prediction time point into an encoder and to learn the first vehicle speed model for predicting a speed of the vehicle, based on the low-dimensional representation (Z), which is an output of the encoder, and a vehicle speed at the prediction time point and a driving profile at the prediction time point that are additionally entered. At the instant time, the controller 40 may predict the speed of the vehicle based on the learned first vehicle speed model.

The controller 40 may control the learning device 30 to enter the time-series data for the driving profile before the prediction time point and the driving profile at the prediction time point into the encoder, and to learn a second vehicle speed model for predicting a speed of a vehicle based on a low-dimensional representation (Z), which is an output of the encoder, and a vehicle speed at the prediction time point which is additionally entered. At the instant time, the controller 40 may predict the speed of the vehicle based on the learned second vehicle speed model.

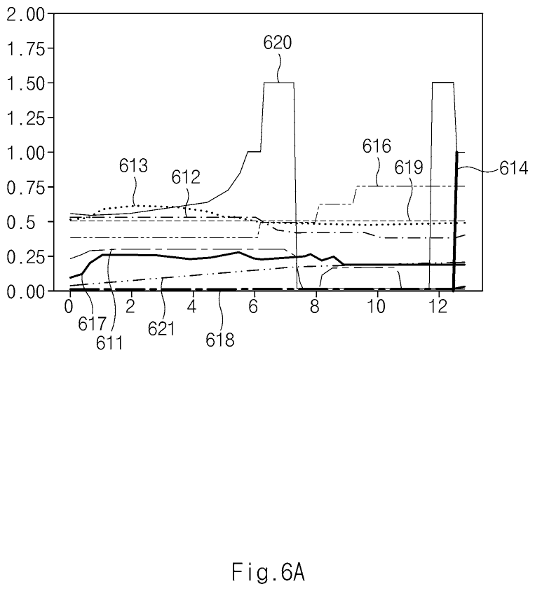

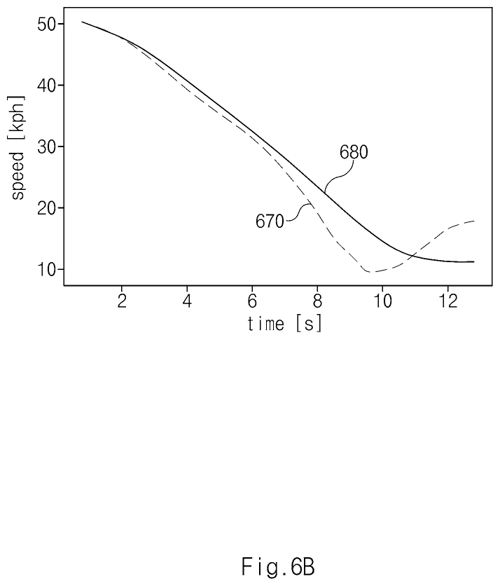

FIG. 6A and FIG. 6B are exemplary diagrams of a performance analysis diagram of a speed prediction device of a vehicle according to various exemplary embodiments of the present invention.

The graph illustrated in FIG. 6A is time-series data for a driving profile before a prediction time point. ‘611’ denotes a GPP value. ‘612’ denotes a gradient of a road. ‘613’ denotes a steering angle. ‘614’ denotes brake on/off. ‘616’ denotes a gear stage. ‘617’ denotes RPM. ‘618’ denotes brake pressure. ‘619’ denotes a relative speed with a preceding vehicle. ‘620’ denotes a curvature of the road. ‘621’ denotes a vehicle speed. The time-series data may further include a graph indicating a separation distance from the preceding vehicle.

The ‘670’ graph illustrated in FIG. 6B indicates an actually-measured vehicle speed under conditions as illustrated in FIG. 6A. The ‘680’ graph illustrated in FIG. 6B indicates a predicted speed of a vehicle based on time-series data (X) illustrated in FIG. 6A. At the instant time, the time-series data (X) has been mapped to Z(−0.00688, −0.06, −0.00746).

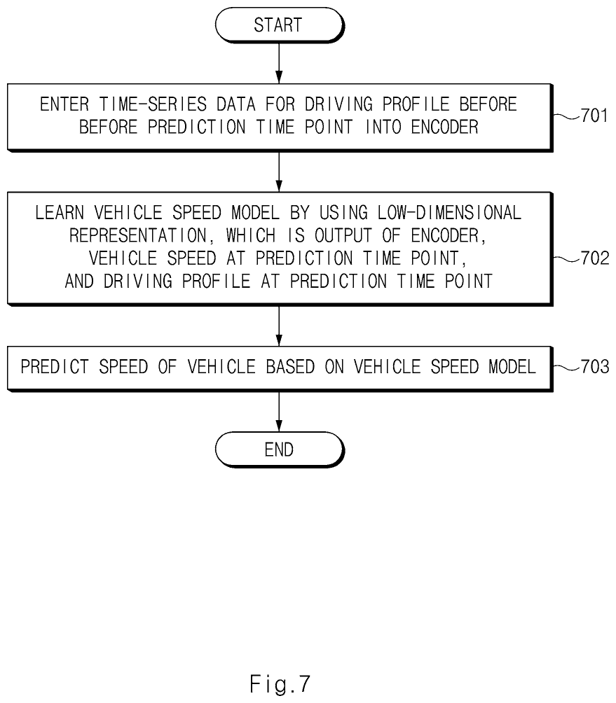

FIG. 7 is a flowchart of a method for predicting a speed of a vehicle according to various exemplary embodiments of the present invention.

First of all, the input device 20 enters time-series data for a driving profile before a prediction time point into an encoder (701).

Afterward, the learning device 30 learns a vehicle speed model by use of a low-dimensional representation which is an output of the encoder, a vehicle speed at the prediction time point, and a driving profile at the prediction time point (702).

Afterward, the controller 40 predicts the speed of the vehicle based on the vehicle speed model (703).

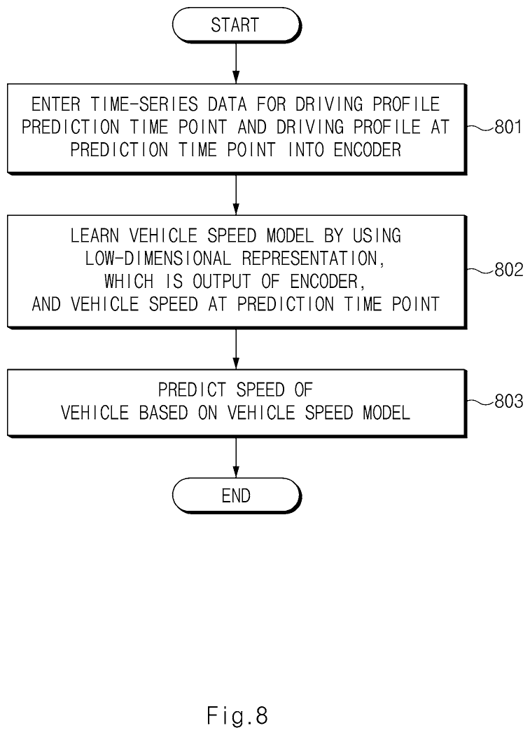

FIG. 8 is a flowchart of a speed prediction method of a vehicle according to various exemplary embodiments of the present invention.

First of all, the input device 20 enters time-series data for a driving profile before a prediction time point and a driving profile at the prediction time point into the encoder (801).

Afterward, the learning device 30 learns a vehicle speed model by use of a low-dimensional representation which is an output of the encoder, and a vehicle speed at the prediction time point (802).

Afterward, the controller 40 predicts the speed of the vehicle based on the vehicle speed model (803).

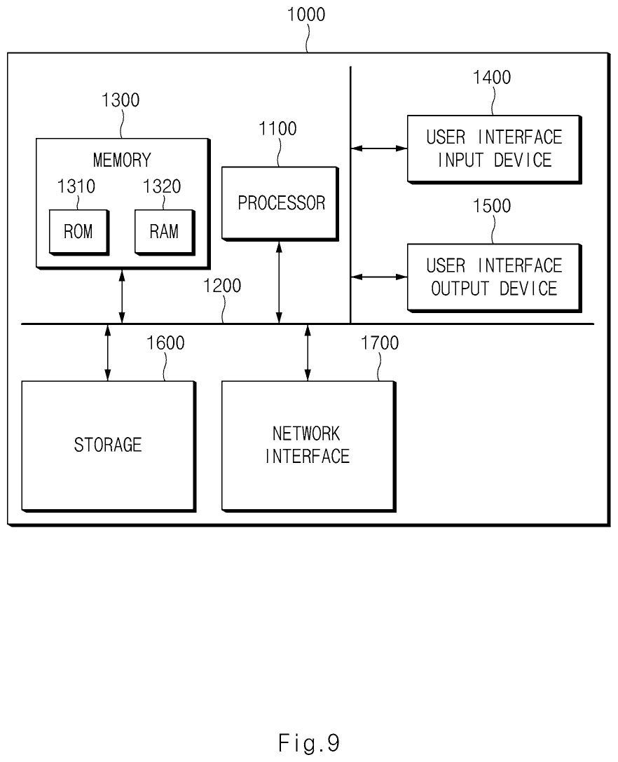

FIG. 9 is a block diagram illustrating a computing system for performing a method of predicting a speed of a vehicle, according to various exemplary embodiments of the present invention.

Referring to FIG. 9, a speed predicting method of a vehicle according to various exemplary embodiments of the present invention may be implemented through a computing system. A computing system 1000 may include at least one processor 1100, a memory 1300, a user interface input device 1400, a user interface output device 1500, storage 1600, and a network interface 1700, which are connected to each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD), a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present invention has been described with reference to exemplary embodiments and the accompanying drawings, the present invention is not limited thereto, but may be variously modified and altered by those skilled in the art to which various exemplary embodiments of the present invention pertains without departing from the spirit and scope of the present invention claimed in the following claims.

Therefore, the exemplary embodiments of the present invention are provided to explain the spirit and scope of the present invention, but not to limit them, so that the spirit and scope of the present invention is not limited by the embodiments. The scope of the present invention may be construed on the basis of the accompanying claims, and all the technical ideas within the scope equivalent to the claims may be included in the scope of the present invention.

According to various exemplary embodiments of the present invention, a device and method for predicting a speed of a vehicle may predict a speed of a vehicle with high accuracy in a form of time-series data, by entering time-series data for a driving profile before a prediction time point into an encoder, learning a vehicle speed model for predicting the speed of the vehicle based on a low-dimensional representation (Z), which is an output of the encoder, and a vehicle speed at a prediction time point and a driving profile at the prediction time point, which are additionally entered, and predicting the speed of the vehicle based on the learned vehicle speed model.

According to various exemplary embodiments of the present invention, a device and method for predicting a speed of a vehicle may predict the speed of the vehicle with high accuracy in a form of time-series data, by entering time-series data for a driving profile before a prediction time point and the driving profile at the prediction time point into an encoder, learning a vehicle speed model for predicting the speed of the vehicle based on the low-dimensional representation (Z), which is the output of the encoder, and the vehicle speed at the prediction time point which is additionally entered, and predicting the speed of the vehicle based on the learned vehicle speed model.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A speed prediction device for predicting a speed of a vehicle according to variational auto-encoder (VAE), the speed prediction device comprising:
an input device configured to enter time-series data for a driving profile before a prediction time point into an encoder;
a learning device including the encoder and configured to learn a vehicle speed model by use of a low-dimensional representation which is an output of the encoder, a vehicle speed at the prediction time point, and a driving profile at the prediction time point; and
a controller configured to generate the predicted speed of the vehicle according to the vehicle speed model.

2. The speed prediction device of claim 1, wherein the driving profile includes at least one of a gas pedal position (GPP) value of the vehicle, a gradient of a road, a steering angle of the vehicle, a brake state of the vehicle, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

3. The speed prediction device of claim 1, wherein the vehicle speed model is used to output the vehicle speed in a format of the time-series data.

4. The speed prediction device of claim 1, wherein the encoder is configured to model a feature of the time-series data for the driving profile before the prediction time point into the low-dimensional representation distributed in a first area.

5. The speed prediction device of claim 4,
wherein the learning device further includes a decoder,
wherein the encoder includes a convolutional neural network and a multi-layer perceptron network,
wherein the decoder includes a multi-layer perceptron network and a deconvolutional neural network to output the predicted speed of the vehicle, and
wherein the low-dimensional representation, the vehicle speed at the prediction time point and the driving profile at the prediction time point are input into the multi-layer perceptron network of the decoder.

6. The speed prediction device of claim 5, wherein the driving profile includes at least one of a gas pedal position (GPP) value of the vehicle, a gradient of a road, a steering angle of the vehicle, a brake state of the vehicle, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

7. The speed prediction device of claim 4,
wherein the learning device further includes a decoder,
wherein the encoder includes a convolutional neural network and a multi-layer perceptron network,
wherein the decoder includes a multi-layer perceptron network and a deconvolutional neural network to output the predicted speed of the vehicle, and
wherein the driving profile at the prediction time point is input to the multi-layer perceptron network of the encoder, and
wherein the low-dimensional representation and the vehicle speed at the prediction time point are input into the multi-layer perceptron network of the decoder.

8. The speed prediction device of claim 7, wherein the driving profile includes at least one of a gas pedal position (GPP) value of the vehicle, a gradient of a road, a steering angle of the vehicle, a brake state of the vehicle, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

9. A speed predicting method for predicting a speed of a vehicle according to a variational auto-encoder (VAE), the method comprising:
entering, by an input device, time-series data for a driving profile before a prediction time point into an encoder;
learning, by a learning device including the encoder, a vehicle speed model by use of a low-dimensional representation which is an output of the encoder, a vehicle speed at the prediction time point, and a driving profile at the prediction time point; and
generating, by a controller, the predicted speed of the vehicle according to the vehicle speed model.

10. The method of claim 9, wherein the driving profile includes at least one of a gas pedal position (GPP) value, a gradient of a road, a steering angle, a brake state, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

11. The method of claim 9, wherein the vehicle speed model is used to output the vehicle speed in a format of the time-series data.

12. The method of claim 9, further including:
modeling, by the encoder, a feature of the time-series data for the driving profile before the prediction time point into the low-dimensional representation distributed in a first area.

13. A speed prediction device for predicting a speed of a vehicle according to variational auto-encoder (VAE), the speed prediction device comprising:
an input device configured to enter time-series data for a driving profile before a prediction time point and a driving profile at the prediction time point into an encoder;
a learning device including the encoder and configured to learn a vehicle speed model by use of a low-dimensional representation which is an output of the encoder, and a vehicle speed at the prediction time point; and
a controller configured to generate the predicted speed of the vehicle according to the vehicle speed model.

14. The speed prediction device of claim 13, wherein the driving profile includes at least one of a gas pedal position (GPP) value of the vehicle, a gradient of a road, a steering angle of the vehicle, a brake state of the vehicle, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

15. The speed prediction device of claim 13, wherein the vehicle speed model is used to output the vehicle speed in a format of the time-series data.

16. The speed prediction device of claim 13, wherein the encoder is configured to model a feature of the time-series data for the driving profile before the prediction time point into the low-dimensional representation distributed in a first area.

17. A speed predicting method for predicting a speed of a vehicle according to a variational auto-encoder (VAE), the method comprising:
entering, by an input device, time-series data for a driving profile before a prediction time point and a driving profile at the prediction time point into an encoder;
learning, by a learning device including the encoder, a vehicle speed model by use of a low-dimensional representation which is an output of the encoder, and a vehicle speed at the prediction time point; and
generating, by a controller, the predicted speed of the vehicle according to the vehicle speed model.

18. The method of claim 17, wherein the driving profile includes at least one of a gas pedal position (GPP) value, a gradient of a road, a steering angle, a brake state, a separation distance of the vehicle from a preceding vehicle, a gear stage of the vehicle, revolutions per minute (RPM) of the vehicle, a brake pressure of the vehicle, a relative speed of the vehicle with the preceding vehicle, or a curvature of the road.

19. The method of claim 17, wherein the vehicle speed model is used to output the vehicle speed in a format of the time-series data.

20. The method of claim 17, further including:
modeling, by the encoder, a feature of the time-series data for the driving profile before the prediction time point into the low-dimensional representation distributed in a first area.
